(19) United States
(12) Patent Application Publication
(10) Pub. No.: US 2009/0132360 A1
(43) Pub. Date: May 21, 2009

(54) PLATFORM / METHOD FOR EVALUATING, AGGREGATING AND PLACING OF RENEWABLE ENERGY GENERATING ASSETS

(76) Inventors: David Arfin, Palo Alto, CA (US); Norman Chaleff, West Orange, NJ (US)

Correspondence Address: FOUNTAINHEAD LAW GROUP, PC, 900 LAFAYETTE STREET, SUITE 509, SANTA CLARA, CA, 95050, US

(21) Appl. No.: 11/942,930

(22) Filed: Nov. 20, 2007

(51) Int. Cl. G06Q 30/00; G06Q 40/00

(52) U.S. Cl. 705/14; 705/37

(57) ABSTRACT

A computerized method and a system for evaluating, aggregating, and placing of renewable energy generating assets are provided. Example embodiments may include reallocating incentives from an investment entity to a property owner to install an energy system on a property associated with the property owner by procuring the energy system by the investment entity based on at least one privileged term; selecting one or more lease terms for a lease of the energy system, transferring the incentives to the property owner; and leasing the energy system by the investment entity to the property owner, using one or more lease terms.

### TECHNICAL FIELD

Example embodiments relate generally to the technical field of energy systems, and in one specific example, to a method and system for evaluating, aggregating, and placing of renewable energy generating assets.

### BACKGROUND

There is a tremendous interest and market momentum for installing solar Photo-Voltaic (PV) systems. In California alone, the market for PV installations may be growing, at 30% annual rate, from $600 million in 2007 to $1.3 billion in 2015 as part of the “Million Solar Roof” initiative.

With Net Metering rules now in place, the ideal usage pattern may include reduced usage during peak periods, so that excess power may be delivered to the utility grid to offset substantially larger amounts of off-peak power received from the utility. The utility savings for a customer may be projected so that the financial payoff is predictable and may typically take from less than 6 years to 15 years or more depending on the variables mentioned above. That is, a solar installation may require a substantial upfront payment with the economic benefit accruing over time in the form of savings from utility bills.

### BRIEF DESCRIPTION OF THE DRAWINGS

Some embodiments are illustrated by way of example and not limitation in the figures of the accompanying drawings in which:

FIG. 1 is a high-level diagram depicting an example functional embodiment of a platform for allocation of incentives from an investment entity to a property owner;

FIG. 2 is a chart illustrating examples of incentives available to a property owner as compared to an investment entity;

FIG. 3 is a block diagram illustrating an example embodiment of a sever for allocation of incentives from an investment entity to a property owner;

FIG. 4 is a chart depicting in an example embodiment a comparison of energy related payments over time by a property owner before and after leasing a solar panel with no buyout option;

FIG. 5 is a chart depicting in an example embodiment cumulative savings by the property owner as a result of leasing the leased solar panel with no buyout option;

FIG. 6 is a chart depicting in an example embodiment a comparison of energy related payments over time by a property owner before and after leasing a solar panel with a 15-year buyout option;

FIG. 7 is a chart depicting in an example embodiment cumulative savings by the property owner as a result of leasing the leased solar panel with a 15-year buyout option;

FIG. 8 is flow diagram illustrating an example embodiment of an online method for allocation of incentives from an investment entity to a property owner;

FIG. 9 is a block diagram illustrating an example embodiment of a Web server hosting a Web site for conducting auctions used for bidding by property owners and investment entities;

FIG. 10 is a block diagram illustrating an example embodiment of a network-based system for allocation of incentives from an investment entity to a property owner;

FIG. 11 is a diagram illustrating multiple example lease and procurement databases used by the system of FIG. 10; and

FIG. 12 is a block diagram illustrating a diagrammatic representation of a machine in the example form of a computer system.

### DETAILED DESCRIPTION

Example methods and systems for evaluating, aggregating, and placing of renewable energy generating assets have been described. In the following description, for purposes of explanation, numerous specific details are set forth to provide a thorough understanding of example embodiments. It will be evident, however, to one skilled in the art, that the present invention may be practiced without these specific details.

For the purpose of present application, the term “leasing” shall be taken to include, but not limited to, power purchase agreement (e.g., paying by the lessee a certain amount per KWH produced by a leased energy system) and renting.

Some example embodiments may provide for the property owner to leverage commercial ownership of their energy systems to be able to enjoy more incentives. The commercial ownership of the energy system may include, for example, leasing the energy system from a commercial entity which may own the energy system and would lease the system to the property owner for a pre-defined period.

Examples of energy systems may include renewable energy sources. Currently, there is a tremendous interest and market momentum for installing solar Photo-Voltaic (PV) panels, particularly in California and other states where substantial rebates for new PV installations provide a strong economic justification for generating renewable energy. The motivation for homeowners and businesses to install solar PV generation on their roofs may include one or more of the following: projected economic savings over the 25-year life of the panels, desire to help the environment, increasing energy independence, resale value of their property, shared community goals toward meeting a Renewable Portfolio Standard (RPS) objective and the marketing benefits associated with being “green.”

In California alone, the market for PV installations may be growing, at 30% annual rate, from $600 million in 2007 to $1.3 billion in 2015 as part of the “Million Solar Roof” initiative. In addition, many other states also have strong incentives for solar installations in place or will likely approve them in 2007. Some state benefits may include exempting installations from property tax basis and sales tax basis. In addition to state rebates for PV installations, the United States Federal Government has also encouraged rapid adoption of solar by funding and extending generous tax incentives for solar installations. The primary federal tax benefits may include an immediate 30% federal tax credit upon installation, usable to reduce regular income tax (currently not AMT), but all residential properties may be limited to a cap of $2,000 for the federal credit if the credit is paid directly to the homeowner as system owner.

The federal tax benefits may also include the ability to depreciate 85% of net cost, rather than 70% (after the 30% credit), and the use of 5 year Modified Accelerated Cost Recover System (MACRS) accelerated depreciation on solar equipment, most of which has a 25-year warranted life.

These federal benefits are in addition to what states or utilities may provide for the users of renewable energy systems in the form of rebates or state tax credits. In California, the largest market for solar energy, the state rebate typically covers 15-30% of the total installed cost (e.g., $2,500 per kilo watt (kW)). For example, a typical cost of a residential solar installation in California may range from $15,000-$75,000 after the state rebates. Some property owners do not benefit from the full federal tax credit (e.g., 30%), because of the existing cap (e.g., $2,000) on federal tax credit benefits for such property owners, and they may not be eligible for the MACRS accelerated depreciation or other depreciation schedules of their energy assets, as commercial owners may be. However, if the same energy system is owned by an investment entity (e.g., a bank, a mortgage company, a partnership, a corporation or a financial institution) and leased to the property owner in a business transaction, the energy system may be considered a commercial system and may qualify for the more generous commercial benefits (e.g., full tax credit and depreciation schedule). The property owner may also acquire the energy system through power purchase agreement (e.g., 15 cents per KWH) with the investment entity.

For example, in a simple case where the actual price of solar energy generation system is $50,000, the property owner may receive $10,000 rebate and be eligible for a $2,000 tax credit. Thus the net investment for the energy system by the property owner may amount to $38,000. Assuming a typical yearly energy saving of $2,000, the break-even point would be 19 years (38,000/2,000=19). In another example scenario, an investment entity may purchase the same system for $50,000 and receive a rebate of at least $10,000. Since the investment entity does not have any cap on the tax credit, it may collect the full 30% benefit, which may amount to $15,000. Moreover, the investment entity may benefit from the depreciation of assets with a present value of an additional $10,000. Consequently, the net cost of the solar energy conversion system to the investment entity amounts to $15,000 (50,000−10,000−15,000−10,000=15,000). The investment entity may be in a position to lease the system to the property owner at such lease terms that the property owner may receive a predefined share of the incentives (extra benefits of $13,000), by leasing the system with buyout option at certain milestones (e.g., 5, 10, or 15 years) and at predefined prices.

Some embodiments described herein may include an on line method for reallocating incentives (e.g., tax credits, such as, low income housing tax credits, new market tax credit, disaster area tax credits; rebates; production-based incentives; feed-in tariffs; Renewable Energy Credits with environmental attributes (REC, also known as “green tags”); and the like) from an investment entity (e.g., a bank, a mortgage company, partnership corporation or a financial institution) to a property owner to install an energy system (e.g., an energy generation system such as, a solar, a wind, or a geothermal energy conversion system) on a property (e.g., a residential property owned by a homeowner or a property owned by a nonprofit organization such as a church, a university, a college, a school, or a commercial property etc.) associated with the property owner. The reallocation may take place by procuring the energy system by the investment entity based on one or more privileged terms; selecting one or more lease terms for a lease of the energy system, lease terms that has the effect of transferring the incentives to or from the property owner; and leasing the energy system by the investment entity to the property owner, based on the at least one lease term transferring the incentives. In an example embodiment, one or more energy incentives, e.g., depreciation schedule, may be reallocated from the property owner to the investment entity.

According to some example embodiments, the privileged terms may be exclusively available to the investment entity. The privileged terms may also include one or more special tax credits or an depreciation schedule. The selecting of the lease term may include performing calculation of at least one benefit to the property owner resulting from the reallocation of the incentive. The reallocation of incentives from the investment entity to the property owner may include installing the leased energy system at the property associated with the property owner.

In some example embodiments, the leasing of the energy system may include a buyout option. The procuring of the energy system may include bidding by the investment entity on an aggregate of energy systems (e.g., energy systems that may be leased to a group of property owners, such as residents of Los Altos Hills, Calif., or the like) using an auction, or based on, a fixed priced transaction or under some formula based on power produced, RECs, etc. For example a Web server may be provided to host a Web site including a first Web page to conduct a first auction, the first auction providing for multiple investment entities to participate in a bidding process to procure one or more energy systems, based on one or more privileged terms.

According to an example embodiment, the property owner may be provided with an opportunity to bid on a lease term using an auction. For example, a second Web page may be presented to conduct a second auction, providing for multiple property owners to participate in a bidding process to lease one or more energy systems using the lease term, including a buyout option.

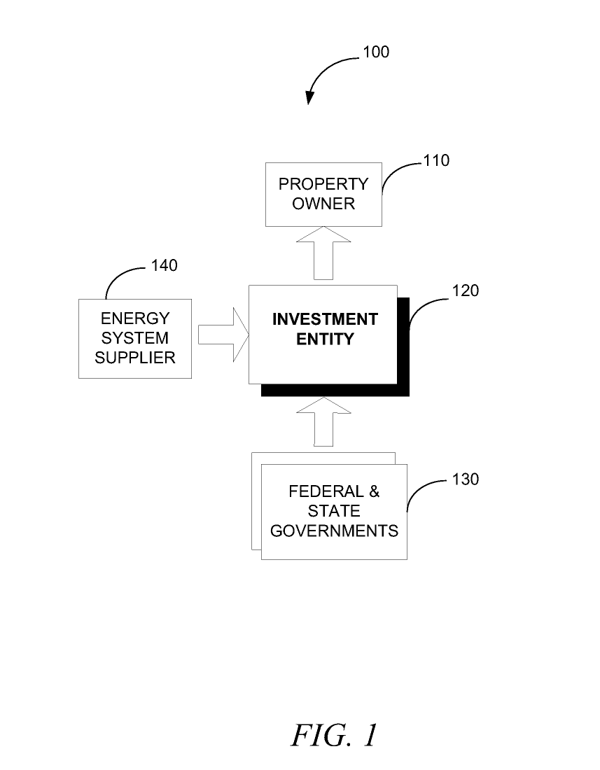

FIG. 1 is a high-level diagram depicting an example functional embodiment 100 of a platform for allocation of incentives from an investment entity to a property owner. The platform 100 may facilitate reallocation of incentives (e.g., tax credits, depreciation schedule, rebates, and renewable energy credits) from an investment entity 120 to a property owner 110. The investment entity 120 may itself receive the incentives from federal and state governments 130 (e.g., tax credits, depreciation schedule, rebates, and renewable energy credits) or from an energy system supplier 140 (e.g., rebates) and pass at least part of those incentives to the property owner 110, which the property owner may choose to assign.

The investment entity 120 may procure the energy system from the energy system supplier 140 (e.g., utility and/or manufacturing companies) based on one or more privileged terms. The privileged terms may be exclusively available to the investment entity 120. The privileged terms may also include one or more special tax credits or an depreciation schedule. The investment entity 120 may then lease the energy system, using the terms provided by the platform 100, to the property owner 110.

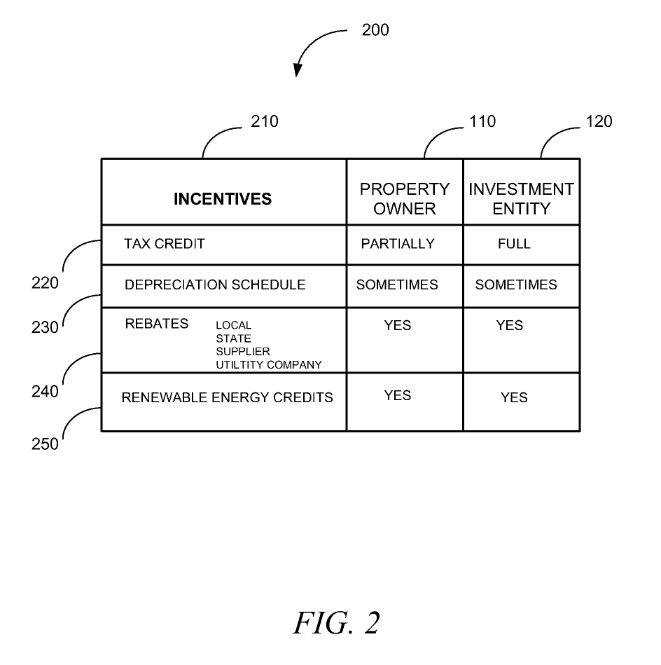

FIG. 2 is a chart illustrating examples of incentives available to a property owner as compared to an investment entity. The incentives 210 are normally provided to promote installation and use of energy systems (e.g., energy generation systems such as a solar, a wind, or a geothermal energy conversion system). In an example embodiment, the incentives 210 may include a tax credit 220, a depreciation schedule 230, rebates 240, and renewable energy credits 250.

According to example embodiments, rebates 240 may be obtained from state governments, local authorities, suppliers, or utility companies. The rebates 240 and renewable energy credits 250 may be available both to the property owner 110 and the investment entity 120 upon purchasing the energy system. The tax credit 220 may only be partially obtainable by property owner 110; whereas, it may be fully accessible to the investment entity 120. The depreciation schedule 230 may sometimes be available to the property owner whereas, it may be fully available to the investment entity 120, if the investment entity is to lease the purchased energy system to a second party, e.g. the property owner 110.

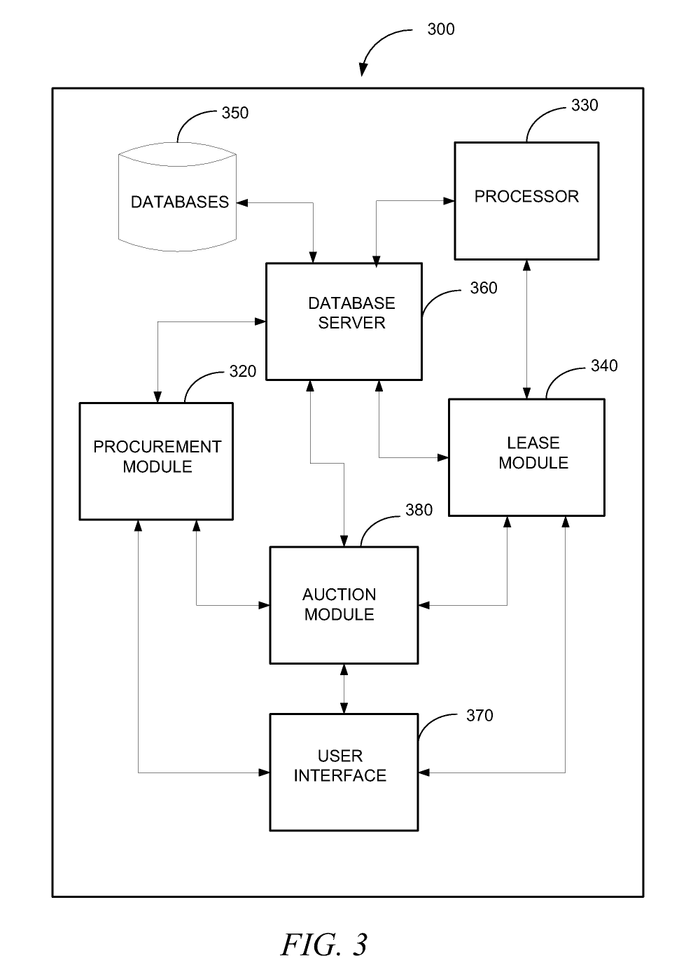

FIG. 3 is a block diagram illustrating an example embodiment of a server 300 for allocation of incentives from an investment entity to a property owner. The server 300 may facilitate reallocation of incentives from the investment entity 120 to the property owner 110 to install an energy system (e.g., energy generation systems such as a solar, a wind, or a geothermal energy conversion system) on a property associated with the property owner 110. The server 300 may include a user interface 370, a procurement module 320, a lease module 340, a processor 330, an auction module 380, databases 350, and a database server 360.

The user interface 370 may communicate, via a network (e.g., the Internet) with the property owner 110 and the investment entity 120 to exchange information between the lease module 340, procurement module 320 or the auction module 380, and the property owner 110 and/or the investment entity 120. The procurement module 320 may allow the investment entity 120 to procure the energy system based on one or more privileged terms from the energy system supplier 140 (e.g. a utility company or manufacturing companies). The privileged terms may be exclusively available to the investment entity 120 and may include a special tax credit 220 and a depreciation schedule 230.

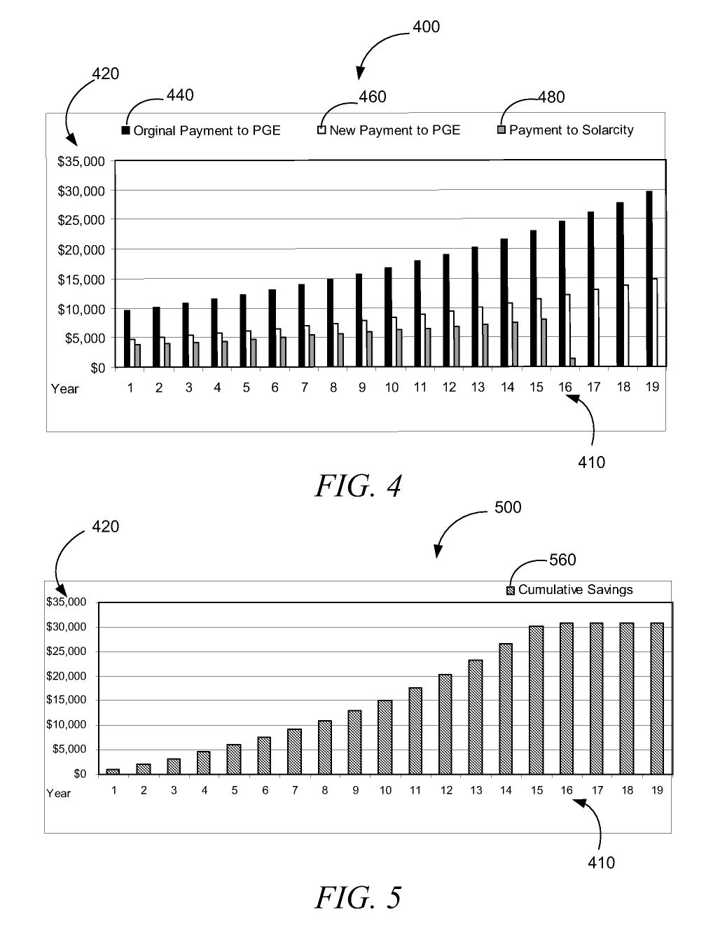

The processor 330 may select one or more lease terms for a lease of the energy system to the property owner 110 transferring the incentives 210 to the property owner 110. The processor 330, for example, may calculate one or more benefits to the property owner resulting from the reallocation of the incentives 210. Example embodiments of such calculated benefits are further described below, in connection with the charts described with reference to FIGS. 4 to 7. The lease module 340 may provide the investment entity 120 with one or more of the lease terms selected by the processor 330, to be used by the investment entity 120 in leasing the energy system to the property owner 110.

According to some example embodiments, the lease terms may include a buyout option for the property owner at certain milestones after acquiring the energy system by the property owner through leasing from the investment entity 120. The lease terms may also include installing of the energy system by the investment entity 120 at the property of the property owner 110.

In some example embodiments, the property of a property owner 110 may include a residential property owned by a homeowner or properties owned by non-profit organizations such as churches, universities, colleges, schools, etc. or commercial owners. The energy system may include an energy generation system including a renewable energy generation system. Renewable energy generation systems may include a solar energy conversion system, a wind energy conversion system, or a geothermal energy conversion system.

In an example embodiment, the auction module 380 may provide for the investment entity 120 to bid on one or more aggregates of energy systems provided by the platform 100. The aggregates of energy systems may include energy systems to be procured and leased to the property owners in a certain geographic location (e.g., region, district, state, city, town, village, locality, or the like) or belonging to certain demographic sectors (e.g., parts of population with yearly income within certain range or working for a certain workplace, etc.).

The auction module 380 may also allow the property owner 110 to make a bid on a lease term for leasing an energy system to be installed on the property of the property owner 110, by a prospective investment entity 120. In the auction conducted by the auction module 380, various investment entities (e.g., a bank, a mortgage company, or a financial institution) may participate to offer their lease packages to prospective bidders, e.g., property owners 110. The lease package may include buyout options at certain milestones and at predefined prices or a process for buying it out based on calculation of Fair Market Value as determined by an agreed upon process such as present value of expected future payments or savings, replacement value or other values.

FIG. 4 is a chart 400 depicting, in an example embodiment, a comparison of energy related payments, over time, by a property owner, before and after leasing solar panels with no buyout option. This chart as well as the ones described below with reference to FIGS. 5-7 may be results of calculations performed by the processor 330 to determine benefits from any lease program provided by an investment entity 120 to a property owner 110. The chart 400 (and the following charts of FIGS. 5-7) may include a horizontal axis 410 representing time after purchasing an energy system (in years), and a vertical axis 420 representing total amounts spent by the property owner 110 at different points in time.

The solid black bars represented by the legend 440 show example energy expenses paid by the property owner 110 to a utility company, e.g. PG&E, for the cost of the consumed energy provided by the utility company over a period of one year. The increasing amount over years of these expenses is the result of including a yearly inflation at a rate of 6.5.

The blank bars represented by the legend 460 show the new payments to the utility company, e.g. PG&E, after leasing, installing, and using a solar panel leased with no buyout option from an investment entity 120 (e.g., SOLARCITY, an energy company based in Foster City, Calif.). The hatched bars represented by legend 480 show the lease payments by the property owner 110 to the investment entity 120 (e.g., SOLARCITY). Comparing the scenarios, that is, the leasing with no payout option of solar panels versus not leasing at all may be performed by the processor 330. An example result of such calculation is presented below with reference to FIG. 5.

FIG. 5 is a chart 500 depicting, in an example embodiment, cumulative savings by the property owner as a result of leasing the leased solar panel with no buyout option. The vertical bars represented by legend 560 show the cumulative savings by the property owner 110 as a result of leasing solar panels with no buyout option as compared to not using any solar energy. As clearly seen from the chart, the cumulative savings may increase until a certain time (e.g., year 16) after which it may almost plateau at an approximate value of $30,000.

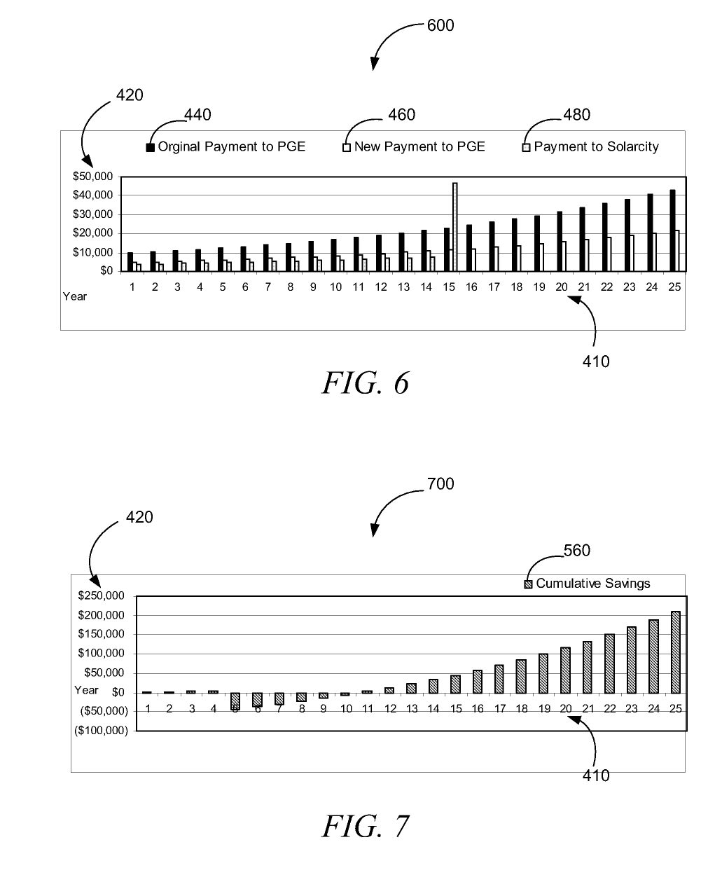

FIG. 6 is a chart 600 depicting, in an example embodiment, a comparison of energy related payments over time by a property owner before and after leasing a solar panel with a year 15 buyout option. In the example chart 600, the lease payments to the investment entity 120, e.g. SOLARCITY, may peak at the year 15, because this is a time when the property owner may have to buy out the lease and, therefore, may have to pay a lump-sum amount of approximately $45,000 to the investment entity 120.

FIG. 7 is a chart 700 depicting, in an example embodiment, cumulative savings by the property owner resulting from leasing a leased solar panel with the 15 year buyout option. According to the example chart 700, after the full lease term of 25 years, the property owner 110 may end up with a cumulative saving of more than $200,000, as a result of leasing solar panels, as compared to the cumulative saving of approximately $30,000 when leasing with no payout option, as shown in FIG. 5.

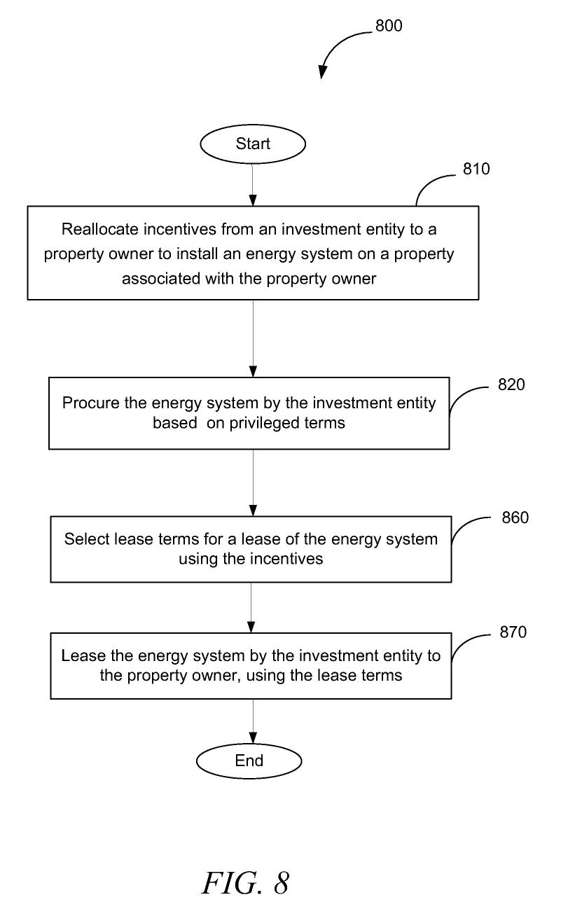

FIG. 8 is a flow diagram illustrating an example embodiment of an online method 800 for allocation of incentives 210 from an investment entity to a property owner. At operation 810, the server 300 may be used by the platform 100 to facilitate for the investment entity 120 to reallocate incentives 210 to the property owner 110. The procurement module 320, at operation 820, may provide the investment entity 120 with information and tools including databases and Web pages assisting the investment entity 120 to procure an energy system (e.g., an energy generation system such as, a solar, a wind, or a geothermal energy conversion system) based on some privileged terms.

According to example embodiments, the privileged terms may be exclusively available to the investment entity 120. The privileged terms may include one or more special tax credits or a depreciation schedule. At operation 860, the processor 330 may calculate a variety of scenarios with different lease terms to select lease terms for the lease of the energy system to the property owner 110, such that incentives 210 can be reallocated from the investment entity 120 to the property owner 110.

At operation 870, the lease module 340 may provide for the investment entity 120 to lease the energy system to the property owner 110, using the lease terms calculated and selected by the processor 330. According to example embodiments, the lease terms may include a buyout option at various points in time after the installation of the energy system (e.g., at years 5, 10, or 15).

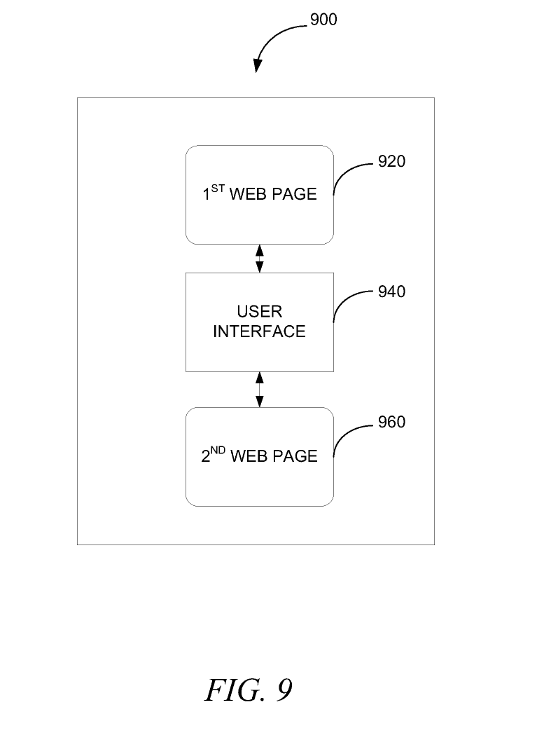

FIG. 9 is a block diagram illustrating an example embodiment of a Web server 900 for hosting a Web site conducting auctions used for bidding by property owners and investment entities. The Web server 900 may include a first Web page 920, a second Web page 960, and a user interface 940. The first Web page 920 may be used to conduct an auction providing for multiple investment companies 120 to participate in a bidding process to procure one or more energy systems based on one or more privileged terms. In an example embodiment, the privileged terms may include special tax credits or accelerated depreciations of assets. The Web server 900 may use the user interface 940 to communicate with the investment entity 120, one or more lease terms for a lease of the energy system from the investment entity 120 to the property owner 110.

According to an example embodiment, the lease term may use incentives 210 including one or more tax credits 220, depreciation schedule 230, rebates 240, or renewable energy credits 250. The second Web page 960 may be used by the Web server 900 to host a Web site conducting an auction providing for multiple property owners 110 to participate in a bidding process to lease one or more energy systems using the lease terms provided by the processor 330. The lease terms may include one or more buyout options for purchasing the energy system by the property owner 110, at predefined prices and at various milestones, after the installation of the energy system (e.g., at years 5, 10, or 15).

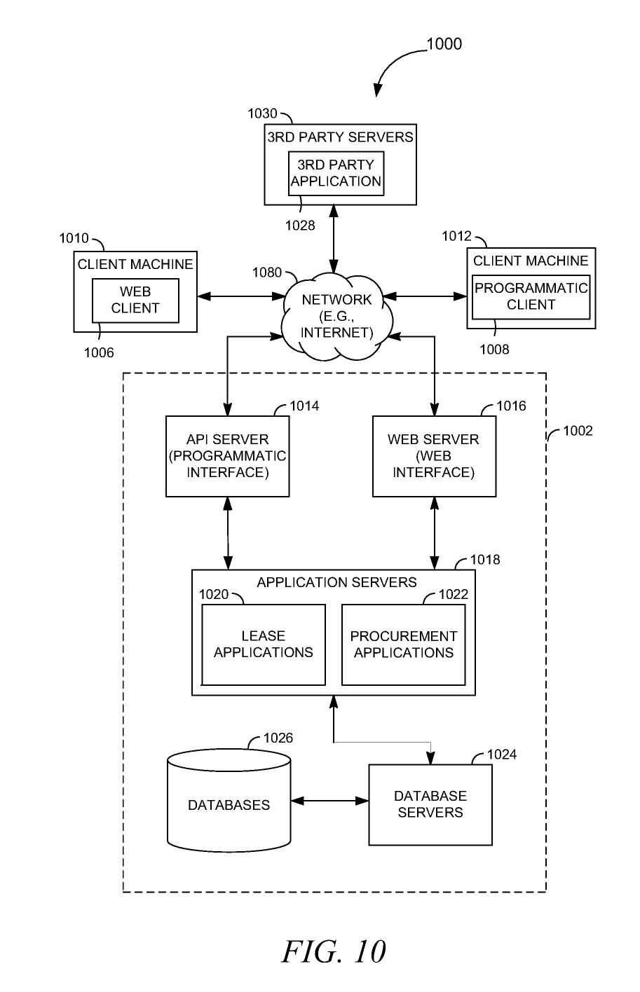

FIG. 10 is a block diagram illustrating an example embodiment of a network-based system 1000 having a client-server architecture used for allocation of incentives from an investment entity to a property owner. An energy system incentives allocation platform, in the example form of a network-based platform 1002, provides server-side functionality, via a network 1080 (e.g., the Internet) to one or more clients. FIG. 10 illustrates, for example, a Web client 1006 (e.g., a browser, such as the Internet Explorer browser developed by Microsoft Corporation of Redmond, Wash.), and a programmatic client 1008 executing on respective client machines 1010 and 1012.

Turning specifically to the network-based platform 1002, an Application Program Interface (API) server 1014 and a Web server 1016 are coupled to, and provide programmatic and Web interfaces respectively to, one or more application servers 1018. The application servers 1018 host one or more lease applications 1020 and procurement applications 1022. The application servers 1018 are, in turn, shown to be coupled to one or more database servers 1024 that facilitate access to one or more databases 1026.

The lease applications 1020 provide a number of financial functions and services to users (e.g., property owner 110) that access the network-based platform 1002 to lease an energy system. The procurement applications 1022 facilitate procurement of energy systems by investment entities 120 for being leased to property owners 110.

Further, while the system 1000 shown in FIG. 10 employs a client-server architecture, the present application is of course not limited to such an architecture and could equally well find application in a distributed, or peer-to-peer, architecture system. The various lease and procurement applications 1020 and 1022 may also be implemented as standalone software programs, which do not necessarily have networking capabilities.

The Web client 1006 may access the various lease and procurement applications 1020 and 1022 via the Web interface supported by the Web server 1016. Similarly, the programmatic client 1008 may access the various services and functions provided by the lease and procurement applications 1020 and 1022 via the programmatic interface provided by the API server 1014. The programmatic client 1008 may, for example, be a lease application to enable a user (e.g., a property owner 110) to lease one or more energy systems form an investment entity 120 and perform batch-mode communications between the programmatic client 1008 and the network-based platform 1002.

FIG. 10 also illustrates a third-party application 1028, executing on a third-party server machine 1030, as having programmatic access to the network-based platform 1002 via the programmatic interface provided by the API server 1014. For example, the third-party application 1028 may, using information retrieved from the network-based platform 1002, support one or more features or functions on a Web site hosted by the third party. The third-party Web site may, for example, provide one or more leasing or procurement operations that are supported by the relevant applications of the network-based platform 1002.

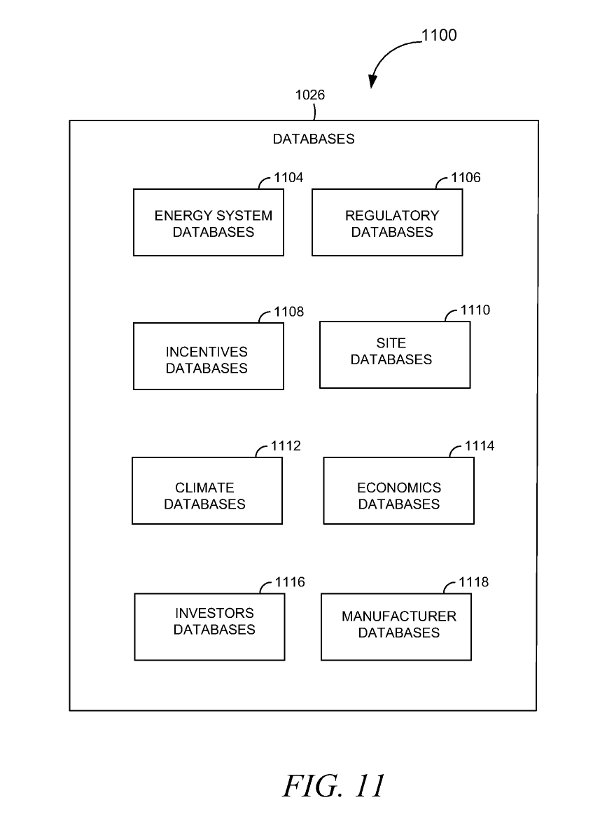

FIG. 11 is a diagram illustrating multiple example lease and procurement databases 1100 that, in one example embodiment, are provided as part of the network-based platform 1002. Energy system databases 1104 may include databases consisting of data tables and records storing data regarding various energy systems including renewable energy generation systems such as solar, wind, and geothermal energy conversion systems. The data on energy systems may include information on manufacturers and vendors of the energy systems, as well as technical data and price information for various components of the systems.

Regulatory databases 1106 may provide the users of the network-based platform 1002 with a collection of rules and regulations established by the federal or state government or local regulatory authorities on various aspects of energy generation such as renewable energy generation promotion, environment protection, taxes, liabilities, and the like.

The network-based platform 1002 may provide access to incentives databases 1108, which supports the property owners 110 and the investment entities 120 in obtaining information on various incentives available to them including tax credits 220, depreciation schedule 230, rebates 240, and renewable energy credits 250.

Site databases 1110 may provide information on sites suitable for renewable energy generation. The information may include maps of areas with various degrees of potential for renewable energy generation including solar, wind, and geothermal energy conversion. In an example embodiment, the site databases 1110 may include solar radiation resource maps including average monthly solar radiation for various areas of the country. The site databases 1110 may also include wind and geothermal energy atlases describing area distribution of wind and geothermal resources.

In some example embodiments, the network-based platform 1002 may provide users with access to other resources including a climate databases 1112 for providing climate information for various geographic locations; economics databases 1114 for presenting renewable energy related economic data including statistics, indicators, and other economic resources; investors databases 1116, including information on prospective investors in energy generation systems; and manufacturer databases 1118, facilitating access to information on a pool of manufacturers of energy systems including renewable energy generation systems and components such as solar panels, batteries, wind turbines, geothermal heat pumps, and the like.

### Machine Architecture

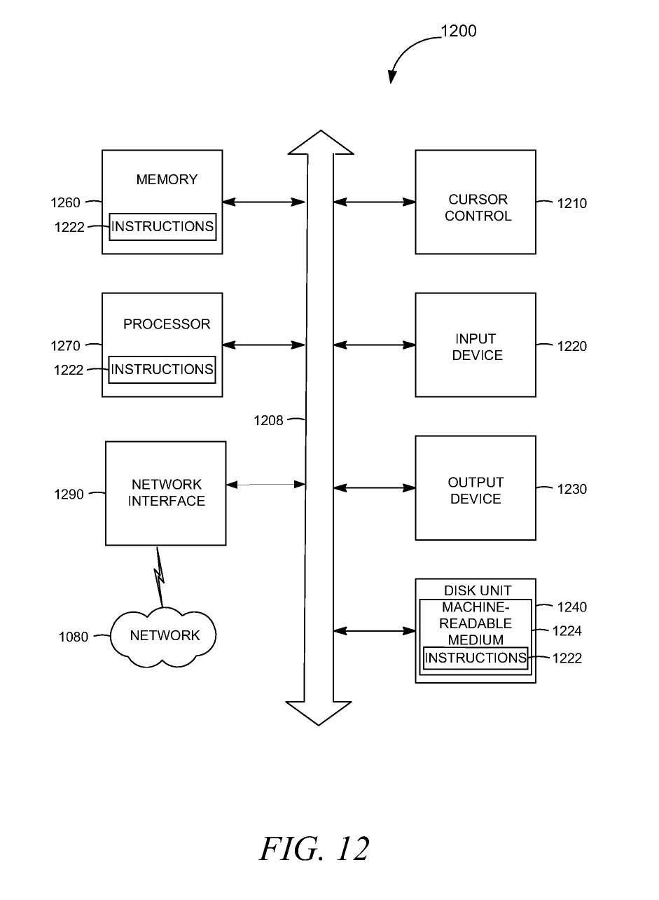

FIG. 12 is a block diagram, illustrating a diagrammatic representation of machine 1200 in the example form of a computer system within which a set of instructions for causing the machine to perform any one or more of the methodologies discussed herein may be executed. In alternative embodiments, the machine 1200 may operate as a standalone device or may be connected (e.g., networked) to other machines. In a networked deployment, the machine 1200 may operate in the capacity of a server or a client machine in a server-client network environment, or as a peer machine in a peer-to-peer (or distributed) network environment.

The machine 1200 may be a server computer, a client computer, a personal computer (PC), a tablet PC, a set-top box (STB), a Personal Digital Assistant (PDA), a cellular telephone, a Web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 may include a processor 1270 (e.g., a central processing unit (CPU), a graphics processing unit (GPU) or both), and a memory 1260, all of which communicate with each other via a bus 1208. The computer system 1200 may further include a output device 1230 (e.g., liquid crystal displays (LCD) or cathode ray tube (CRT)). The computer system 1200 also may include an input device 1220 (e.g., a keyboard), a cursor control 1210 (e.g., a mouse), a disk unit 1240, and a network interface 1290.

The disk unit 1240 may include a machine-readable medium 1224 on which is stored one or more sets of instructions (e.g., software 1222) embodying any one or more of the methodologies or functions described herein. The software 1222 may also reside, completely or at least partially, within the memory 1260 and/or within the processor 1270 during execution thereof by the computer system 1200, the memory 1260, and the processor 1270 also constituting machine-readable media.

The software 1222 may further be transmitted or received over a network 1080 via the network interface device 1290.

While the machine-readable medium 1224 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present invention. The term “machine-readable medium” shall accordingly be taken to include, but not be limited to, solid-state memories and optical and magnetic media.

Thus, a method and a system for evaluating, aggregating, and placing of renewable energy generating assets have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computerized method comprising:
reallocating incentives from an investment entity to a property owner to install an energy system on a property associated with the property owner by,
procuring the energy system by the investment entity based on at least one privileged term;
selecting at least one lease term for a lease of the energy system, then at least one lease term transferring the incentives to the property owner; and
leasing the energy system by the investment entity to the property owner, using the at least one lease term.

2. The computerized method of claim 1, wherein the incentives include at least one of tax credits, rebates, production-based incentives, feed-in tariffs, depreciation, or Renewable Energy Credits (REC).

3. The computerized method of claim 1, including reallocating of one or more incentives from the property owner to the investment entity.

4. The computerized method of claim 3, wherein the energy system is a renewable energy system including at least one of:
a solar energy conversion system,
a wind energy conversion system, or
a geothermal energy conversion system.

5. The computerized method of claim 1, wherein the at least one privileged term is exclusively available to the investment entity.

6. The computerized method of claim 1, wherein the at least one privileged term includes at least one of a special tax credit and an depreciation schedule.

7. The computerized method of claim 1, wherein the selecting includes performing calculation of an at least one benefit to the property owner resulting from the reallocation of the incentives.

8. The computerized method of claim 1, including installing the leased energy system at the property.

9. The computerized method of claim 1, wherein the leasing of the energy system includes a buyout option.

10. The computerized method of claim 1, wherein the procuring includes bidding by the investment entity on an aggregate of energy systems using an auction.

11. The computerized method of claim 10, wherein the aggregate of energy systems includes energy systems to be leased to a group of property owners.

12. The computerized method of claim 1, including bidding by the property owner on a lease term using an auction.

13. A system comprising:
a server to facilitate a reallocation of incentives from an investment entity to a property owner to install an energy system on a property associated with the property owner, the server including:
a user interface to communicate with at least one of the investment entity or the property owner;
a procurement module to allow the investment entity to procure the energy system based on at least one privileged term;
a processor to select at least one lease term for a lease of the energy system, the at least one lease term using the incentives; and
a lease module to assist the investment entity in leasing the energy system to the property owner, based on the at least one lease term transferring the incentives.

14. The system of claim 13, wherein the server is to facilitate the reallocation of the incentives including at least one of tax credits, rebates, depreciation or Renewable Energy Credits (REC).

15. The system of claim 13, wherein the processor is to calculate an at least one benefit to the property owner resulting from the reallocation of the incentives.

16. The system of claim 13, wherein the procurement module is to allow the investment entity to procure the energy system based on at least one privileged term, the at least one privileged term being exclusively available to the investment entity.

17. The system of claim 13, wherein the procurement module is to allow the investment entity to procure the energy system based on at least one privileged term, the at least one privileged term including at least one of a special tax credit or an depreciation schedule.

18. The system of claim 13, wherein the lease module is to provide for the property owner to lease the energy system using the at least one lease term, the at least one lease term including a buyout option.

19. The system of claim 13, wherein the lease module is to provide for the property owner to lease the energy system using the at least one lease term, the at least one lease term including installing by the investment entity of the energy system at the property.

20. The system of claim 13, including an auction module to allow the investment entity to bid on an aggregate of energy systems.

21. The system of claim 20, wherein the auction module is to allow the property owner to bid on a lease term.

22. A system comprising:
means for reallocating incentives from an investment entity to a property owner to install an energy system on a property associated with the property owner including:
means for procuring the energy system by the investment entity based on at least one privileged term;
means for selecting at least one lease term for a lease of the energy system, the at least one lease term transferring the incentives to the property owner; and
means for leasing the energy system by the investment entity to the property owner, based on the at least one lease term transferring the incentives.

23. A machine-readable medium comprising instructions, which when implemented by one or more processors perform the following operations:
reallocating incentives from an investment entity to a property owner to install an energy system on a property associated with the property owner by,
procuring the energy system by the investment entity based on at least one privileged term;
selecting at least one lease term for a lease of the energy system, the at least one lease term transferring the incentives to the property owner; and
leasing the energy system by the investment entity to the property owner, based on the at least one lease term transferring the incentives.

24. A system comprising:
a Web server to host a Web site, the Web site including:
a first Web page to conduct a first auction, the first auction providing for a plurality of investment entities to participate in a bidding process to procure at least one energy system based on at least one privileged term,
a user interface to communicate to the investment entity at least one lease term for a lease of the at least one energy system, the at least one lease term using incentives, the incentives to be reallocated from the investment entity to the property owner; and
a second Web page to conduct a second auction, the second auction providing for a plurality of property owners to participate in a bidding process to lease the at least one energy system based on the at least one lease term transferring the incentives.

25. A system comprising:
a Web server to host a Web site, the Web site including:
a first Web page to conduct a first auction, the first auction providing for a plurality of investment entities to participate in a bidding process to procure at least one energy system based on at least one privileged term, the at least one privileged term including at least one of a special tax credit or depreciation schedule.
a user interface to communicate to the investment entity at least one lease term for a lease of the at least one energy system, the at least one lease term using incentives, the incentives to be reallocated from the investment entity to the property owner and including at least one of tax credits, rebates, or Renewable Energy Credits (REC); and
a second Web page to conduct a second auction, the second auction providing for a plurality of property owners to participate in a bidding process to lease at least one energy system, the at least one energy system using the at least one lease term, the at least one lease term including a buyout option.
